(19) United States
(12) Patent Application Publication
(10) Pub. No.: US 2025/0332917 A1
(43) Pub. Date: Oct. 30, 2025

(54) VEHICLE, SYSTEM AND METHOD FOR PROVIDING MANUAL OF VEHICLE TERMINAL

(71) Applicants: Hyundai Motor Company, Seoul (KR); Kia Corporation, Seoul (KR)

(72) Inventor: Jae Yoon KO, Yongin-si (KR)

(21) Appl. No.: 18/888,408

(22) Filed: Sep. 18, 2024

(30) Foreign Application Priority Data
Apr. 29, 2024 (KR) 10-2024-0057096

(51) Int. Cl. B60K 35/22; G06F 8/65; H04W 4/44

(52) U.S. Cl. CPC B60K 35/22; G06F 8/65; H04W 4/44; B60K 2360/161

(57) ABSTRACT

A vehicle can include a vehicle terminal. The vehicle terminal may include a communication module configured to receive update software from a first server, and a processor configured to provide address information of a website providing a manual corresponding to the update software to a second server communicating with a user terminal, the address information being delivered to the user terminal linked to the vehicle.

### CROSS REFERENCE TO RELATED APPLICATION(S)

The present application claims the benefit of priority under 35 U.S.C. 119 to Korean Patent Application No. 10-2024-0057096, filed on Apr. 29, 2024, in the Korean Intellectual Property Office, the entire content of which is incorporated herein for all purposes by this reference.

### TECHNICAL FIELD

The disclosure relates to providing a vehicle terminal manual, and more particularly, to a vehicle and a vehicle terminal manual provision system and method capable of providing a vehicle terminal manual to a user terminal without direct interaction between the vehicle terminal and the user terminal.

### BACKGROUND

Vehicles are equipped with various systems to provide information or entertainment. For example, infotainment systems are widely integrated into vehicles, allowing users to access both informative features and entertainment options.

Infotainment systems include terminals that provide various multimedia and information services. Users may need to consult a manual for using these terminals effectively.

To facilitate this, terminals store QR codes that link to terminal manuals. Users can scan these codes with their personal devices, such as smartphones, to access manual websites.

However, users must scan the terminal's QR code with their personal devices, which requires familiarity with menu operations to access the code. This process can be inconvenient, especially when trying to access the terminal manual from outside the vehicle.

Moreover, while users can access the manual via a connected car application or web browser on their personal device, these applications encounter challenges in accurately determining the software version installed on the vehicle terminal. This often results in users having to manually search for the correct manual, adding to the inconvenience.

### BRIEF SUMMARY

The present disclosure is directed to a vehicle and a vehicle terminal manual provision system and method facilitating convenient access to vehicle terminal manuals for users.

Furthermore, the present disclosure is directed to a vehicle and a vehicle terminal manual provision system and method capable of allowing users to access the manual of the vehicle terminal from the user terminal without direct interaction between the vehicle terminal and the user terminal even from outside the vehicle.

According to one aspect of the present disclosure, a vehicle can include a vehicle terminal, and the vehicle terminal can include a communication module configured to receive update software from a first server, and a processor configured to provide address information of a website providing a manual corresponding to the update software to a second server communicating with a user terminal, the address information being delivered to the user terminal linked to the vehicle.

In some implementations, the processor can transmit the address information, which is provided separately from the update software, to the second server.

In some implementations, the processor can transmit, in response to installation of the updated software, the address information provided by the update software to the second server.

In some implementations, the vehicle terminal can be an infotainment terminal.

According to another aspect of the present disclosure, a vehicle terminal manual provision system can include a vehicle terminal configured to provide vehicle terminal manual website information, a first server configured to transmit the vehicle terminal manual website information provided by the vehicle terminal to an external device, and a user terminal configured to access a website based on the vehicle terminal manual website information transmitted from the first server, receive a manual for the vehicle terminal from the website, and output the received manual.

In some implementations, the vehicle terminal manual provision system can further include a second server configured to provide the vehicle terminal manual website information to the vehicle terminal, wherein the vehicle terminal may transmit the vehicle terminal manual website information provided from the second server to the first server.

In some implementations, the second server can provide the vehicle terminal manual website information in response to requesting for software update for the vehicle terminal.

In some implementations, the user terminal can output the vehicle terminal manual website information through a user interface, access, based on the vehicle terminal manual website information being selected, the website, and receive the manual for the vehicle terminal.

In some implementations, the vehicle terminal manual website information can include a link to the vehicle terminal manual website.

According to another aspect of the present disclosure, a vehicle terminal manual provision method can include providing, by a vehicle terminal, vehicle terminal manual website information to a first server, transmitting, by the first server, the vehicle terminal manual website information to a user terminal, and accessing, by the user terminal, a website based on the vehicle terminal manual website information received from the first server, receiving a manual for the vehicle terminal from the website, and outputting the received manual.

In some implementations, the vehicle terminal manual provision method can further include providing, by the second server, the vehicle terminal manual website information to the vehicle terminal, wherein the providing of the vehicle terminal manual website information to the first server may include transmitting, at the vehicle terminal, the vehicle terminal manual website information provided from the second server to the first server.

In some implementations, the providing of the vehicle terminal manual website information to the vehicle terminal can be performed in response to requesting for software update for the vehicle terminal.

In some implementations, the receiving of a manual for the vehicle terminal from the website can include outputting, by the user terminal, the vehicle terminal manual website information through a user interface, and accessing, based on the vehicle terminal manual website information being selected, the website to receive the manual for the vehicle terminal.

In some implementations, the vehicle terminal manual website information can include a link to a vehicle terminal manual website, and the receiving of a manual for the vehicle terminal from the website may include accessing the website linked to the link to receive the manual for the vehicle terminal.

According to implementations of these features, a vehicle and a vehicle terminal manual provision system can allow users to conveniently access the manual of the vehicle terminal.

According to implementations of these features, a vehicle and a vehicle terminal manual provision system can allow users to access the manual of the vehicle terminal even from outside the vehicle.

According to implementations of these features, a vehicle and a vehicle terminal manual provision system can allow users to access the manual of the vehicle terminal from the user terminal without direct interaction between the vehicle terminal and the user terminal.

According to implementations of these features, the vehicle terminal manual provision technology can allow users to easily access the manual of the vehicle terminal even from outside the vehicle.

According to implementations of these features, user inconvenience can be alleviated by allowing users to access the manual of the vehicle terminal without requiring users to enter the vehicle and connect the user terminal to the vehicle terminal.

### BRIEF DESCRIPTION OF THE DRAWINGS

FIG. 1 is a diagram illustrating an example of a vehicle terminal manual provision system 1.

FIG. 2 is a block diagram illustrating an example of the vehicle terminal 200.

FIG. 3 is a block diagram illustrating an example of the user terminal 400.

FIG. 4 is a flowchart illustrating an example of a vehicle terminal manual provision method.

FIG. 5 is a signal flow diagram illustrating an example of the interaction between components for the operations in FIG. 4.

### DETAILED DESCRIPTION

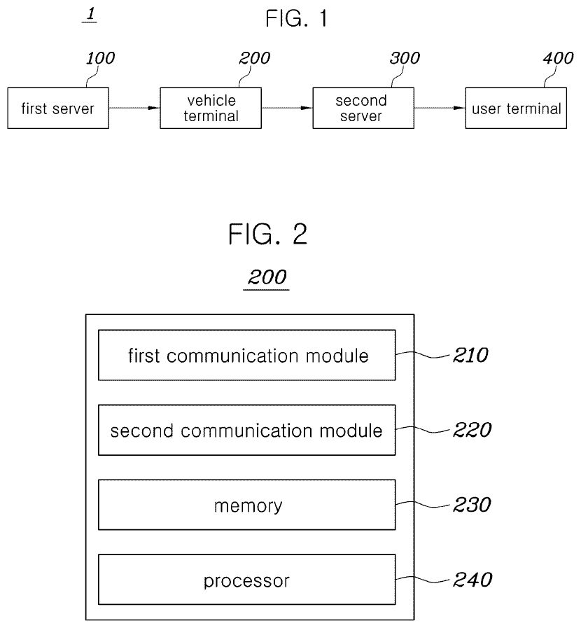

FIG. 1 is a diagram illustrating an example of a vehicle terminal manual provision system 1.

With reference to FIG. 1, the vehicle terminal manual provision system 1 (hereinafter, the system) can include a first server 100, a vehicle terminal 200, a second server 300, and a user terminal 400, and the configuration of the system 1 is not limited thereto.

In some implementations, the first server 100 can update the software of the vehicle terminal 200. For example, the first server 100 can update the software of the vehicle terminal 200 using the over-the-air (OTA) method.

The first server 100 can refer to an “OTA server” or “software update server.” The first server 100 can be operated by the manufacturer or seller of the vehicle terminal 200, but this is not an exhaustive list.

The first server 100 can transmit software update request messages to the vehicle terminal 200.

The first server 100 can transmit, to the vehicle terminal 200, a software update request message including information, such as information about a website (hereinafter, vehicle terminal manual website information) providing manuals of software (or vehicle terminal 200), and the files or information provided by the first server 100 are not limited thereto.

In some implementations, software may refer to what is installed on the vehicle terminal 200 for operation of the vehicle terminal 200, and software manual and vehicle terminal manual can be used interchangeably with the same meaning.

Based on software for update being installed on the vehicle terminal 200, vehicle terminal manual website information can be stored in the vehicle terminal 200 by the software for update. In some implementations, the first server 100 can provide the vehicle terminal 200 with the software for update and vehicle terminal manual website information in a separate software update request message.

In some implementations, the vehicle terminal manual website information can include a link to the vehicle terminal manual website.

The first server 100 can include at least one processor, at least one memory, and at least one communication module, and the configuration of the first server 100 is not limited thereto.

The at least one memory can store software for update and vehicle terminal manual website information. The at least one processor can provide the software for update and vehicle terminal manual website information stored in the at least one memory to the vehicle terminal 200 via the communication module. For example, the communication module can be configured to communicate with the vehicle terminal 200 via a predetermined wireless communication method, and transmit to the vehicle terminal 200 the software for update and vehicle terminal manual website information provided by the at least one processor.

In some implementations, the vehicle terminal 200 can be installed inside the vehicle to provide various information and entertainment to the driver or passengers.

The vehicle terminal 200 can serve as an infotainment terminal, and the type of the vehicle terminal 200 is not limited thereto.

The vehicle terminal 200 can be updated based on the software for update provided by the first server 100. For example, the vehicle terminal 200 can receive software for update from the first server 100 and be updated by installing the provided software for update.

In some implementations, the vehicle terminal 200 can receive vehicle terminal manual website information from the first server 100 and provide the received information to the second server 300.

FIG. 2 is a block diagram illustrating an example of the vehicle terminal 200.

With reference to FIG. 2, the vehicle terminal 200 can include a first communication module 210, a second communication module 220, a memory 230, and a processor 240, and the configuration of the vehicle terminal 200 is not limited thereto.

The first communication module 210 can communicate with the first server 100 via a predetermined wireless communication method. In some implementations, the first communication module 210 can receive software for update and vehicle terminal manual website information provided by the first server 100.

The first communication module 210 can store the received software for update and vehicle terminal manual website information in the memory 230 and then transmit the software for update and vehicle terminal manual website information to the processor 240.

The second communication module 220 can communicate with the second server 300 via a predetermined wireless communication method. For example, the second communication module 220 can transmit the vehicle terminal manual website information provided by the processor 240 to the second server 300.

The memory 230 can store software (or algorithms or programs) for the operation of the vehicle terminal 200 and information for the operation of the vehicle terminal 200. For example, the memory 230 can store software for update and vehicle terminal manual website information provided by the first server 100.

The memory 230 can include volatile memory and/or non-volatile memory. The volatile memory may include dynamic random access memory (DRAM), static RAM (SRAM), synchronous DRAM (SDRAM), phase-change RAM (PRAM), magnetic RAM (MRAM), resistive RAM (RRAM), and ferroelectric RAM (FeRAM). The non-volatile memory may include read-only memory (ROM), programmable ROM (PROM), electrically programmable ROM (EPROM), electrically erasable programmable ROM (EEPROM), and flash memory.

The processor 240 can execute operations or data processing related to the control of at least one other component of the vehicle terminal 200. For example, the processor 240 can execute algorithms stored in the memory 230.

The processor 240 can process received data as well as data stored in the memory 230. The processor 240 can execute computer-readable code (e.g., algorithms) stored in the memory 230 and instructions triggered by the processor 240.

The processor 240 can be implemented as a hardware data processing device with a circuit having a physical structure to execute desired operations. For example, the desired operations can encompass codes or instructions included in the program.

For example, the hardware-implemented data processing device can encompass microprocessors, central processing units (CPUs), processor cores, multi-core processors, multiprocessors, application-specific integrated circuits (ASICs), and field programmable gate arrays (FPGAs).

In some implementations, the processor 240 can update the software of the vehicle terminal 200 by installing the software for update provided by the first server 100.

In some implementations, the processor 240 can transmit the vehicle terminal manual website information provided by the first server 100 to the second server 300.

With reference to FIG. 1, the second server 300 can receive the vehicle terminal manual website information provided by the vehicle terminal 200. In response to receiving the vehicle terminal manual website information, the second server 300 can transmit an acknowledgment (ack) signal to the vehicle terminal 200.

In some implementations, the second server 300 can transmit the vehicle terminal manual website information to the user terminal 400 via a predetermined wireless communication method.

The second server 300 can be operated by the manufacturer or seller of the vehicle terminal 200, but this is not an exhaustive list. The second server 300 can transmit the vehicle terminal manual website information to the user terminal 400 through interaction with a service program installed on the user terminal 400.

The second server 300 can include at least one processor, at least one memory, and at least one communication module, and the configuration of the second server 300 is not limited thereto.

The at least one memory can store the vehicle terminal manual website information received from the vehicle terminal 200. The processor can provide the vehicle terminal manual website information stored in the memory to the user terminal 400. For example, the communication module can communicate with the vehicle terminal 200 and the user terminal 400 via a predetermined wireless communication method, store the vehicle terminal manual website information received from the vehicle terminal 200 in the memory, and transmit the vehicle terminal manual website information provided by the processor to the user terminal 400.

The user terminal 400 can receive the vehicle terminal manual website information from the second server 300. In response to receiving the vehicle terminal manual website information, the user terminal 400 can transmit an acknowledgment (ack) signal to the second server 300.

In response to receiving the vehicle terminal manual website information, the user terminal 400 can display the website information to the user via the user interface.

In some implementations, the user terminal 400 can be implemented with a service application configured to provide various services related to the vehicle. For example, the service application can be implemented to provide information related to the vehicle terminal 200. The service application can be implemented to provide vehicle terminal manual website information related to the vehicle terminal 200.

When the service application is running on the user terminal 400, the user terminal 400 can display the information provided by the service application on the user interface.

In some implementations, the information provided by the service application can include the vehicle terminal manual website information. For example, the user terminal 400 can display the vehicle terminal manual website information provided by the service application through the interface.

In some implementations, the vehicle terminal manual website information can include a link to the website of the vehicle terminal manual, allowing the user terminal 400 to access the linked website and obtain the manual for the vehicle terminal.

As described above, the user terminal 400 can provide manuals related to the vehicle terminal 200 without direct interaction with the vehicle terminal 200. Consequently, users can easily access manuals related to the vehicle terminal 200 via the user terminal 400 even outside the vehicle.

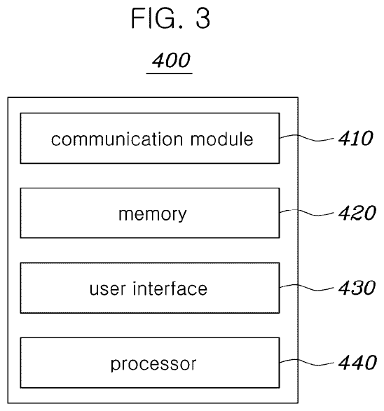

FIG. 3 is a block diagram illustrating an example of the user terminal 400.

With reference to FIG. 3, the user terminal 400 can include a communication module 410, a memory 420, a user interface 430, and a processor 440, and the configuration of the user terminal 400 is not limited thereto.

The communication module 410 can communicate with the second server 300 using a predetermined wireless communication method. In some implementations, the communication module 410 can receive vehicle terminal manual website information from the second server 300.

The communication module 410 can store the received vehicle terminal manual website information in the memory 420.

The memory 420 may store software (or algorithms or programs) for the operation of the user terminal 400 and information for the operation of the user terminal 400. For example, the memory 420 can store the vehicle terminal manual website information from the second server 300.

In some implementations, the memory 420 can store a service application and the vehicle terminal manual website information from the second server 300.

The memory 420 can include volatile memory and/or non-volatile memory. The volatile memory can include dynamic random access memory (DRAM), static RAM (SRAM), synchronous DRAM (SDRAM), phase-change RAM (PRAM), magnetic RAM (MRAM), resistive RAM (RRAM), and ferroelectric RAM (FeRAM). The non-volatile memory can include read-only memory (ROM), programmable ROM (PROM), electrically programmable ROM (EPROM), electrically erasable programmable ROM (EEPROM), and flash memory.

The user interface 430 can output the information provided by the processor 440 in a predetermined manner. The user interface 430 can output a graphical user interface (GUI). For example, the user interface 430 can display the vehicle terminal manual website information on the graphical user interface (GUI).

The user interface 430 can perform input functions as well as output functions. For example, the user interface 430 can receive user selections as input and output the selection signal to the processor 440. In some implementations, when the vehicle terminal manual website information displayed on the graphic user interface (GUI) of the user interface 430 is selected, the user interface 430 can output a selection signal to the processor 440.

The processor 440 can execute operations or data processing related to the control of at least one other component of the user terminal 400. For example, the processor 440 can execute algorithms and applications stored in the memory 420.

The processor 440 can process received data as well as data stored in the memory 420. The processor 440 can execute computer-readable code (e.g., algorithms) stored in the memory 420 and instructions triggered by the processor 440.

The processor 440 can be implemented as a hardware data processing device with a circuit having a physical structure to execute desired operations. For example, the desired operations can encompass codes or instructions included in the program.

For example, the hardware-implemented data processing device can include microprocessors, central processing units (CPUs), processor cores, multi-core processors, multiprocessors, application-specific integrated circuits (ASICs), and field programmable gate arrays (FPGAs).

In some implementations, the processor 440 can execute the service application stored in the memory 420 and output various information provided by the service application to the user interface 430.

For example, the processor 440 can output the vehicle terminal manual website information and establish, when the vehicle terminal manual website information is selected, a connection based on a predetermined wireless communication method to access the website corresponding to the vehicle terminal manual website information.

In this case, the processor 440 can access the website using the communication module 410 or another communication module. For example, the website can be managed by the first server 100 or by a separate server.

The processor 440 can download the software manual provided on the accessed website, store the downloaded software manual in the memory 420, and output the manual in real-time based on streaming. For example, the software manual can be provided in video format or in file format.

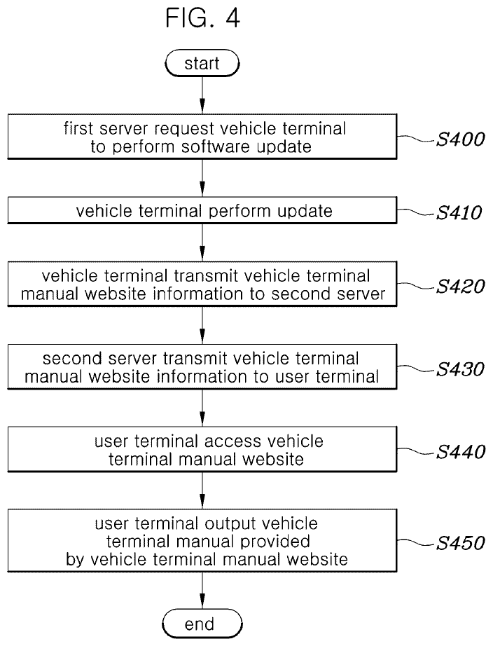

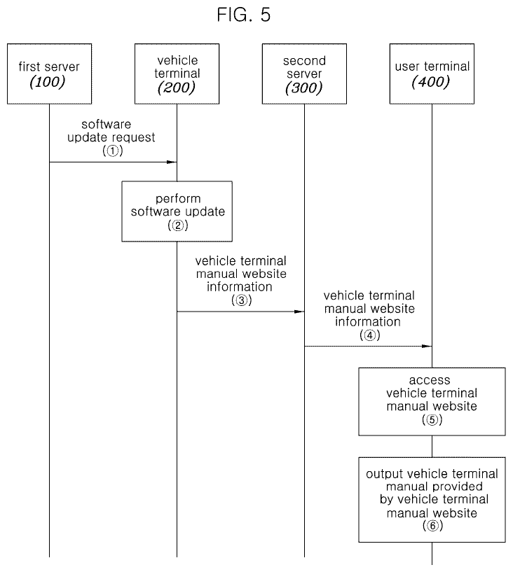

FIG. 4 is a flowchart illustrating an example of a vehicle terminal manual provision method, and FIG. 5 is a signal flow diagram illustrating an example of the interaction between components for the operations in FIG. 4.

With reference to FIG. 1, FIG. 2, FIG. 3, FIG. 4, and FIG. 5, the first server 100 may, at step S400 ((\textcircled{1}), request the vehicle terminal 200 to perform a software update.

At step S400, the first server 100 can transmit, to the vehicle terminal 200, a software update request message including software for update and vehicle terminal manual website information. For example, the software for update can include vehicle terminal manual website information and provide, based on the software for update installed on the vehicle terminal 200, vehicle terminal manual website information to the vehicle terminal 200.

Subsequent to step S400, the vehicle terminal 200 can perform the update at step S410 (\textcircled{2}) and transmit the vehicle terminal manual website information to the second server 300 at step S420 (\textcircled{3}).

Subsequent to step S420, the second server 300 can transmit the vehicle terminal manual website information to the user terminal 400 at S430 (\textcircled{4}).

Subsequent to step S430, the user terminal 400 can access, at step S440 ((\textcircled{5}), the software manual website corresponding to the vehicle terminal manual website information, and output, at step S450 (\textcircled{6}), the software manual provided by the accessed software manual website via the user interface.

In some implementations, the vehicle terminal manual website information can include a link to the website of the vehicle terminal manual, allowing the user terminal 400 to access the linked website and obtain the manual for the vehicle terminal.

What is claimed is:

1. A vehicle comprising:
a vehicle terminal comprising:
a communicator configured to receive, from a first server, a software for performing updates; and
a processor configured to transmit, to a second server configured to communicate with a user terminal, address information of a website providing a manual corresponding to the software for performing updates, the user terminal being configured to receive, from the second server, the address information and operably connected to the vehicle.

2. The vehicle of claim 1, wherein the address information is provided, from the first server, separately from the software for performing updates.

3. The vehicle of claim 1, wherein the processor is configured to, based on installation of the software being performed, transmit the address information from the software to the second server.

4. The vehicle of claim 1, wherein the vehicle terminal is an infotainment terminal.

5. A vehicle terminal manual provision system, the system comprising:
a vehicle terminal configured to provide vehicle terminal manual website information;
a first server;
a second server configured to transmit the vehicle terminal manual website information provided by the vehicle terminal to an external device; and
a user terminal configured to:
access a website based on the vehicle terminal manual website information transmitted from the second server,
receive a manual for the vehicle terminal from the website, and
output the received manual.

6. The system of claim 5, wherein the first server is configured to provide the vehicle terminal manual website information to the vehicle terminal,
wherein the vehicle terminal is configured to transmit the vehicle terminal manual website information provided from the first server to the second server.

7. The system of claim 6, wherein the first server is configured to, based on a request for software update being transmitted, transmit the vehicle terminal manual website information.

8. The system of claim 5, wherein the user terminal is configured to:
output the vehicle terminal manual website information through a user interface,
access, based on the vehicle terminal manual website information being selected, the website, and
receive the manual for the vehicle terminal.

9. The system of claim 5, wherein the vehicle terminal is an infotainment terminal.

10. The system of claim 5, wherein the vehicle terminal manual website information comprises a link to a vehicle terminal manual website.

11. A vehicle terminal manual provision method, the method comprising:
transmitting, by a vehicle terminal, vehicle terminal manual website information to, among a first server and a second server, the second server;
transmitting, by the second server, the vehicle terminal manual website information to a user terminal;
accessing, by the user terminal, a website based on the vehicle terminal manual website information received from the second server;
receiving, at the user terminal, a manual for the vehicle terminal from the website; and
outputting, at the user terminal, the received manual.

12. The method of claim 11, further comprising:
providing, by the first server, the vehicle terminal manual website information to the vehicle terminal,
wherein providing the vehicle terminal manual website information to the second server comprises transmitting, by the vehicle terminal, the vehicle terminal manual website information provided from the first server to the second server.

13. The method of claim 12, wherein providing the vehicle terminal manual website information to the vehicle terminal is performed based on a request for software update for the vehicle terminal being transmitted.

14. The method of claim 11, wherein receiving a manual for the vehicle terminal from the website comprises:
outputting, at the user terminal, the vehicle terminal manual website information through a user interface; and
accessing, based on the vehicle terminal manual website information being selected, the website to receive the manual for the vehicle terminal.

15. The method of claim 11, wherein the vehicle terminal manual website information comprises a link to a vehicle terminal manual website, and
wherein receiving a manual for the vehicle terminal from the website comprises accessing the website associated with the link to receive the manual for the vehicle terminal.
